(19) United States
(12) Patent Application Publication
(10) Pub. No.: US 2026/0194437 A1
(43) Pub. Date: Jul. 9, 2026

(54) Method and System for Determining Nanotube and/or Nanowire Lengths

(71) Applicant: Rutgers, The State University of New Jersey, New Brunswick, NJ (US)

(72) Inventors: Jerry W. SHAN, Piscataway, NJ (US); Richard J. CASTELLANO, New Brunswick, NJ (US)

(73) Assignee: Rutgers, The State University of New Jersey, New Brunswick, NJ (US)

(21) Appl. No.: 18/868,282

(22) PCT Filed: May 25, 2023
(86) PCT No.: PCT/US2023/023503

§ 371 Date: Nov. 22, 2024

(51) Int. Cl. G01N 15/0227; B82Y 35/00; G01B 11/02; G01N 15/00; G01N 15/02

(52) U.S. Cl. CPC G01N 15/0227; G01B 11/02; G01N 15/0266; B82Y 35/00; G01N 2015/0038; G01N 2015/0057; G01N 2015/03

(57) ABSTRACT

Methods of determining the length of nanowires and/or carbon nanotubes (CNTs), as well as systems for performing the same are provided. The methods and systems include the use of passing a polarized light beam through a sample container that is situated between parallel plate electrodes and subjected to a varying electric field. Measurement of the dichroism amplitude in the sample allows for the determination of nanowire and/or CNT lengths in the sample.

### CROSS-REFERENCE TO RELATED APPLICATION

This application claims priority under 35 U.S.C. § 119 (e) to U.S. Provisional Patent Application No. 63/345,860, entitled “METHOD AND SYSTEM FOR DETERMINING NANOTUBE AND/OR NANOWIRE LENGTHS,” filed May 25, 2022, the disclosure of which is incorporated herein by reference in its entirety.

### STATEMENT REGARDING FEDERALLY SPONSORED RESEARCH

This invention was made with government support under grant no. BA12PHM123 awarded by the Defense Threat Reduction Agency. The government has certain rights in the invention.

### BACKGROUND

Currently, dynamic light scattering (DLS) technology can be used to characterize several types of nanoparticles including nanorods and nanowires. However, measuring CNT (carbon nanotubes) via DLS gives the diameter of a sphere that diffuses at the same rate as the particle. In some types of DLS experiments, one can determine rotational and translational diffusion coefficients from depolarized DLS measurements to obtain the length and diameter of the rods, but this method provides inaccurate measurements for rod like particles.

There is thus an unmet need in developing methods and systems for accurately determining the length of CNTs, nanowires, and other 1D (one-dimensional) particles. The presently disclosed methods and systems solve this need.

### BRIEF SUMMARY OF THE INVENTION

In one aspect, a method of measuring nanowire or carbon nanotube (CNT) lengths is provided.

In certain embodiments, the method includes illuminating a sample comprising a plurality of nanowires or CNTs with a polarized laser light source. In certain embodiments, the method includes applying an electric potential to the sample with a plurality of electrodes. In certain embodiments, the method includes monitoring the sample dichroism amplitude as a function of the electric potential and direction of the polarized laser light to determine the nanowire or CNT lengths in the sample.

In one aspect, a system for measuring nanowire or carbon nanotube (CNT) length is provided.

In certain embodiments, the system includes a laser light source. In certain embodiments, the system includes a first polarizer. In certain embodiments, the system includes a plurality of electrodes. In certain embodiments, the system includes a sample container through which the laser light passes. In certain embodiments, the system includes a detector to detect the dichroism amplitude of light passing through the sample container.

### BRIEF DESCRIPTION OF THE FIGURES

The drawings illustrate generally, by way of example, but not by way of limitation, various embodiments of the present application.

FIG. 1 is a non-limiting schematic of a CNT in suspension with an applied E-field and the resultant torque on the induced dipole.

FIG. 2 is a non-limiting depiction of perspective projection. The CNT in suspension is aligned at an angle of θ with the y-axis, with the polar angle ψ about the y-axis. Such on orientation of the CNT results in an observed angle of φ on the y-z plane imaging.

FIGS. 3A-3B shows non-limiting measurement of electrostatic potential and degree of alignment. (FIG. 3A) Length dependence on the degree of alignment of CNTs. The CNTs were observed to fluctuate in alignment angle which allowed for the experimental alignment energy U to be extracted. (FIG. 3B) Variation of degree of alignment with E-field for two sizes of nano-tubes. Five short nanotubes (L=0.90-1.12 μm) and five long nanotubes (L=1.86-2.21 μm) were each studied under seven fields between 23 and 160 V/mm. At each voltage, the CNT fluctuated under thermal energies for 35 sec. Theoretical curves were generated based on the average length of the short and long CNTs.

FIGS. 4A-4D show non-limiting magnetically functionalized CNTs. (FIG. 4A) Image of CNT suspension after creation. (FIG. 4B) After being placed next to a magnet for 30 minutes, the CNTs are observed to deposit on the side of the vial due to magnetophoresis. (FIG. 4C) EDX colored SEM image of a CNT with Fe₃O₄ nanoparticles on the CNT. Both small ~10 nm particles and a larger ~200 nm particle can be seen on the CNT, and the CNT is resting on a Si wafer. (FIG. 4D) SEM image of a CNT with ~10 nm Fe₃O₄ nanoparticles on the CNT.

FIGS. 5A-5B is a non-limiting schematic showing the concept behind dichroism modulation by electric-field-induced alignment of CNTs in suspension. (FIG. 5A) Schematic of CNTs randomly aligned in suspension between two electrodes without the application of an E-field. (FIG. 5B) When an E-field is applied, CNTs align and their degree of alignment can be quantified by measuring the sample dichroism, or anisotropy in the optical absorption for light polarized in different directions.

FIGS. 6A-6B depict the non-limiting theory behind length measurement technique. (FIG. 6A) Theoretical degree of alignment (alignment order parameter) for 0.8 nm diameter CNTs subject to E-fields in DCB. The general scaling is similar for different nanotubes or nanowires in fluid suspensions. (FIG. 6B) Graph depicting the E-field necessary to achieve a given value of S for a given tube length. For a reliable dichroism measurement for a given length, E-fields should be applied spanning the entire shaded region, at a minimum.

FIG. 7 is a non-limiting image of a dichroism measurement setup, in accordance with various embodiments.

FIG. 8 is a non-limiting schematic of a dichroism measurement setup, in accordance with various embodiments.

FIGS. 9A-9D show non-limiting images of the dichroism measurement setup, in accordance with various embodiments. (FIG. 9A) Image of the laser beam passing through a Ag NW suspension in a 4-cm-path-length cuvette. The laser is visible due to scattering off suspended Ag NWs. (FIG. 9B) Image of the cuvette in the cuvette holder with electrical leads connected to the electrodes. (FIG. 9C) Images of the polished 316 stainless steel electrodes held in place with PTFE spacers and PTFE screws. (FIG. 9D) Image of the DSA-4472 card with SMB cables connected to the photodiode and the motor encoder.

FIG. 10 is a non-limiting image of the front panel of the LabVIEW program used to record the dichroism and motor-encoder signals.

FIG. 11 shows non-limiting dichroism signal intensity for 0.00001 g/L 2024 CNTs with different applied voltages. The value on the x-axis is periodic, so recorded signal values from a few seconds of real time all collapse. One rotation of the motor takes 0.033 sec. For better visibility, each signal except the first is offset by an arbitrary voltage V_{shift} so the signals are stacked one on top of the other for better visibility.

FIGS. 12A-12B illustrate non-limiting measured dichroism signal for different E-field strengths. (FIG. 12A) Dichroism amplitude increase as a 19.0 V/mm E-field is applied to a 0.0001 g/L sample of 2024 CNTs treated with bath sonication. (FIG. 12B) The same CNT sample with a 100.4 V/mm E-field applied.

FIGS. 13A-13B show non-limiting dichroism response of a sample of 0.005 g/L of LX1018 SWNT bundles and extracted length distribution. (FIG. 13A) Dichroism amplitude as function of E-field. The consistency between the first (quickly recorded) and second run of the experiment demonstrates that the sample remained stable over the course of the experiment. The best fit for the second data set is graphed as a dashed line. The alignment regimes describe above are also indicated. (FIG. 13B) Extracted length distributions using the procedure described above. Error bars are the standard deviation of the extracted distributions from nine fitting runs using randomized initial conditions. The regimes labeled on the diagram indicate how the features of the dichroism amplitude graph correspond with the features in the length distribution.

FIG. 14 shows non-limiting dependence of the dichroism length measurement on the assumed particle diameter. The length-measurement technique uses an assumed particle diameter to extract the length, but the assumed diameter only has a slight effect on the measured length distribution. In this case, the close to two-orders-of-magnitude change in the particle diameter only changes the mean of the extracted length distribution by 21%.

FIGS. 15A-15B show validation of method using SWNT forests grown by LLNL to a mostly uniform length, in accordance with various embodiments. (FIG. 15A) SEM image of SWNT bundles on a Si wafer. (FIG. 15B) Comparison between SEM-measured length histogram and dichroism-measured length histogram.

FIGS. 16A-16B show non-limiting length measurement of LX0710 CNTs grown on a Si wafer. (FIG. 16A) Optical image of the LX0710 CNTs in suspension. (FIG. 16B) Comparison of the optically-measured and dichroism-measured samples. The agreement for longer tubes validates the measurement, while shorter tubes may not be captured by the optical imaging. The dashed box represents the quoted length of the CNTs on the Si wafer.

FIGS. 17A-17B show non-limiting validation of method using silver nanowires, in accordance with various embodiments. (FIG. 17A) SEM image of Ag NWs on a Si surface. (FIG. 17B) Dichroism-measured length histogram of a 0.001 g/L suspension of Ag NWs compared to the length measurement by SEM.

FIGS. 18A-18B show non-limiting results of bath sonication vs. tip sonication for CNTs. (FIG. 18A) Dichroism signal intensity for samples of CHASM SWNTs treated with different sonication procedures. Arrows indicate a bump in the curves characteristic of ~2-4 μm long CNTs. (FIG. 18B) Zoomed in version of (FIG. 18A) depicting where the signals have a clear bump indicating the presence of ~2-4 μm long CNTs or CNT bundles in suspension.

FIGS. 19A-19D show non-limiting histograms of the CNT lengths measured by the dichroism technique for different sonication procedures. (FIG. 19A) Mass-fraction histogram of a 0.0001 g/L 2024 CNT suspension treated with 1 hour total bath sonication only. (FIG. 19B) Mass fraction histogram of the same sample treated with an additional 3 minutes of tip sonication. The increased short-tube content is presumably due to tip sonication breaking the CNTs. (FIG. 19C) Mass fraction histogram of a 0.00001 g/L 2024 SWNT sample bath sonicated overnight. For this sample, the concentration was lowered to eliminate hysteresis. (FIG. 19D) Comparison of the three histograms overlaid on the same plot.

FIGS. 20A-20B show non-limiting SEM images of PXD2-2024 CNT bundles after sonication in DCE (dichloroethane) and dried on a silicon wafer. DCE was chosen as a solvent for imaging because of its volatility.

FIGS. 21A-21C show non-limiting aspects of the method and apparatus described herein, according to certain embodiments. FIG. 21A depicts a schematic of a suitable system for carrying out the methods described herein. FIG. 21B shows that for a weak E-field, particles have a random orientation, while for a medium E-field longer particles will align while shorter particles will be more randomly orientated, and for even stronger E-fields both long and short particles will experience a high degree of alignment. FIG. 21C shows various magnitudes of the E-field. At E-fields of 2.2 V/mm the dichroism is hardly visible, while the dichroism increases from 16-54 V/mm, the dichroism signal saturates as E increases beyond 54 V/mm.

FIGS. 22A-22B show non-limiting examples of such dichroism signal responses for silver nanowires and carbon nanotube bundles graphed as a function of the applied E-field, along with inset SEM images of the respective particles dried on silicon wafers.

FIGS. 22C-22F show that the fitting is precise enough to extract bimodal length distributions and distributions with statistical dispersion. LX0710: CNT length 6-8 μm, CNT diameter 1.79=0.67 nm. LX1018: CNT length 12-13 μm, CNT diameter 2.32±0.85 nm. LX051019: CNT length 8.3 μm, CNT diameter 2.39±0.85 nm.

FIG. 23 shows that the technique for determining nanotube or nanowire lengths is relatively insensitive to the assumed diameter of the particle or particle bundles. For example, if the 2.32-nm-diameter CNTs were in bundles with an effective diameter of 100-nm, the extracted mean length would only vary by 20% (10.8 microns vs 13.5 microns).

FIG. 24 illustrates that the methods described herein, in certain embodiments, utilize an assumed particle diameter to ensure that the particle length is the only adjustable parameter to fit, and large variations in particle diameter only have a slight effect on the extracted length distribution.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl.

Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═C═CCH₂, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C═CH, —C═C(CH₃), —C═C(CH₂CH₃), —CH₂C═CH, —CH₂C═C(CH₃), and —CH₂C═C(CH₂CH₃) among others.

The term “unsaturated hydrocarbon” as used herein refers to compounds containing on or more alkenyl and/or alkynyl groups, as defined herein.

The term “cyclic” as used herein with respect to chemical compounds refers to rings containing the stated number of carbon atoms, including polycyclic ring systems.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aromatic hydrocarbon” as used herein refers to a compound containing an aryl group, as defined herein.

The term “alcohol” as used herein refers to a compound with the stated number of carbons in which at least one hydrogen atom is replaced by a hydroxyl group (—OH).

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0) wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “room temperature” as used herein refers to a temperature of about 15° C. to 28° C.

The term “standard temperature and pressure” as used herein refers to 20° C. and 101 kPa.

### Methods of Determining Lengths of Carbon Nanotubes, Nanowires, and Other 1D Nanoparticles

In various embodiments, a method of measuring nanowire or carbon nanotube (CNT) length is provided. The method includes at least one of the following steps:
illuminating a sample comprising a plurality of nanowires or CNTs with a polarized laser light source;
applying an electric potential to the sample with a plurality of electrodes; and
monitoring the sample dichroism amplitude as a function of the electric potential and direction of the polarized laser light to determine the length of the sample.

The nanowires can be any “one-dimensional” (high aspect ratio) material, such as materials where the largest width dimension (e.g. a diameter for cylindrical wires or tubes), is at least 20, 50, 100, 500, 103, or 104-times shorter than the length dimension, and where the length dimension is defined as the longest dimension in the nanomaterial. The material composition of the nanowire does not limit the effectiveness of the systems or methods described herein, provided that the nanowire material is conductive. Examples of conductive nanowires include metal nanowires, such as silver, copper, or gold nanowires; nanowires containing mixtures of metals; and nanowires containing metal oxides, such as TiO₂ and the like. Conductive biological nanowires such as microbial nanowires can also be measured, for example, nanowires produced by Geobacter sp. and Shewanella sp. The lengths of the nanowire suitable for analysis by the methods and systems described herein, can be from about 0.1 to about 15 μm, or at least, equal to, or greater than about 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 μm.

CNTs can be single-wall carbon nanotubes (SWCNT) or multi-wall carbon nanotubes (MWCNT), including functionalized derivatives of SWCNTs and MWCNTs. As with nanowires, the CNTs can be any CNT where the largest width dimension (e.g. a diameter for cylindrical wires or tubes), is at least 20, 50, 100, 500, 103, or 104-times shorter than the length dimension, and where the length dimension is defined as the longest dimension in the CNT. The lengths of the CNTs suitable for analysis by the methods and systems described herein, can be from about 0.1 to about 15 μm, or at least, equal to, or greater than about 0.1, 0.2, 0.3, 0.4, 0.5, 0.6, 0.7, 0.8, 0.9, 1, 2, 3, 4, 5, 6, 7, 8, 9, 10, 11, 12, 13, 14, or 15 μm.

The polarized laser light source can be any suitable laser source that produces laser light in at a wavelength of about 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, or about 700 nm. In various embodiments, the polarized laser light source is produced by passing an unpolarized laser light through a polarizer.

In various embodiments, the plurality of electrodes include two parallel plate electrodes. The parallel plate electrodes can be made of any suitable electrode material, such as metals, metal oxides, and combinations thereof. Suitable metals include steel, copper, gold, platinum, aluminum, and the like. The electrodes can optionally be coated with a non-conductive material such as glass or a polymer such as polystyrene, polyethylene, and the like. The shape of the electrodes is not particularly limited, and can be square, rectangular, circular, ellipsoid, and the like. In various embodiments, the electrodes are square or rectangular. The electrodes, in some embodiments, have identical physical dimensions. In various embodiments, the electrodes have a surface area of about 0.5 to about 200 cm² or at least, greater than, or equal to about 0.5, 1, 1.5, 2, 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 60, 65, 70, 75, 80, 85, 90, 95, 100, 105, 110, 115, 120, 125, 130, 135, 140, 145, 150, 155, 160, 165, 170, 175, 180, 185, 190, 195, or 200 cm².

In various embodiments, the method includes positioning at least one of a diverging lens, converging lens, aperture, polarizer, or rotating half-wave plate. In some embodiments, the laser light passes through at least one of diverging lens, converging lens, aperture, polarizer, or rotating half-wave plate before passing through the sample.

In various embodiments, the sample is positioned between the parallel plate electrodes. The sample can be, for example, in an container that permits laser light to pass through it. The sample can be equidistant from each electrode, in some embodiments. The space between the electrode surface(s) and the surface of the container containing the sample can be filled with air, inert gas such nitrogen or argon, vacuum, or with a solid non-conductive material such as a resin or polymer.

In various embodiments, the sample includes a nanowire or CNT suspension. The nanowire or CNT suspension is, in some embodiments, composed of the nanowire or CNT sample to be analyzed and a solvent, or a mixture of solvents, including hydrocarbon solvents, polar aprotic solvents, and polar protic solvents. Suitable solvents include C₅-C₂₀ alkyl or cycloalkyl hydrocarbons, C₅-C₂₀ unsaturated cyclic or acyclic hydrocarbons, C₆-C₁₀ aromatic hydrocarbons, C₂-C₁₀ cyclic or acyclic alcohols, halogenated analogs of the foregoing, and the like.

In various embodiments, the polarized laser light passes through the sample and into a photodetector. The photodetector can be any photosensor that can suitably detect the change in dichroism amplitude of the laser light passing through the sample. Suitable photodetectors include, but are not limited to, gaseous ionization detectors, photomultiplier tubes, microchannel plate detectors, active-pixel sensors, charge-coupled devices, photoresistors, phototransistors, quantum dot photoconductors or photodiodes, photovoltaic cells, polarization-sensitive photodetectors containing optically anisotropic materials, and the like. In certain embodiments, the photodetector includes at least one photodiode.

In certain embodiments, the monitoring includes changing the electric potential applied to the sample and measuring at least one of: 1) no increase in the dichroism amplitude; 2) a proportional increase in the dichroism amplitude with increasing electric potential; or 3) a levelling-off of the dichroism amplitude with increasing electric potential. In certain embodiments, changing the electrical potential includes increasing the potential from 0 to a maximum potential value or decreasing the potential from a maximum potential value to 0. In various embodiments, the maximum potential value is determined by observing the electrical potential at which no measurable increase in dichroism amplitude occurs as the electrical potential is increased.

Also described is a system for measuring nanowire or carbon nanotube (CNT) length using the methods described herein. In certain embodiments, the system includes a laser light source. In certain embodiments, the system includes a first polarizer. In certain embodiments, the system includes a plurality of electrodes. In certain embodiments, the system includes a sample container through which the laser light passes. In certain embodiments, the system includes a detector to detect the dichroism amplitude of light passing through the sample container.

The laser light source can be any suitable laser source that produces laser light in at a wavelength of about 380, 385, 390, 395, 400, 405, 410, 415, 420, 425, 430, 435, 440, 445, 450, 455, 460, 465, 470, 475, 480, 485, 490, 495, 500, 505, 510, 515, 520, 525, 530, 535, 540, 545, 550, 555, 560, 565, 570, 575, 580, 585, 590, 595, 600, 605, 610, 615, 620, 625, 630, 635, 640, 645, 650, 655, 660, 665, 670, 675, 680, 685, 690, 695, or about 700 nm. Suitable laser light sources include gas-based lasers such as HeNe, Ar, Kr, Xe, and the like; dye-based lasers using dyes such as stilbene, coumarin, rhodamine 6G and the like; metal vapor lasers such as HeCd, Helg, HeSe, strontium vapor, copper vapor, gold vapor, manganese vapor, and the like; solid-state lasers such as ruby, Nd:YAG, Er:YAG, Ti:sapphire, and the like; and semiconductor lasers such as GaN and InGaN, and the like.

In various embodiments, the system includes comprising at least one of a diverging lens, converging lens, aperture, polarizer, or rotating half-wave plate. Suitable polarizers include polarizing filters composed of materials such as tourmaline, herapathite, doped polyvinyl alcohol (PVA), nanoparticle-embedded glass, quartz, calcite, and the like. In various embodiments, the first polarizer is a polarizing filter as described herein.

In various embodiments, the sample container includes a sample of nanowires or carbon nanotubes (CNT) in a liquid suspension. The container can be made of any suitable material that allows transmission of light, such as glass, quartz, or other transparent crystal or ceramic material. The nanowire or CNT suspension is, in some embodiments, composed of the nanowire or CNT sample to be analyzed and a solvents, or a mixture of solvents, including hydrocarbon solvents, polar aprotic solvents, and polar protic solvents. Suitable solvents include C₅-C₂₀ aliphatic hydrocarbons, C₅-C₂₀ unsaturated hydrocarbons, C₆-C₁₀ aromatic hydrocarbons, C₂-C₁₀ alcohols, halogenated analogs of the foregoing, and the like. In certain embodiments, the solvent is hexadecane. In certain embodiments, the solvent is dichlorobenzene. In various embodiments, the concentration of the nanowires or CNTs in the suspension is about 1×10⁻² to about 1×10⁻⁵ g/L.

In various embodiments, the plurality of electrodes are two parallel-plate electrodes as described herein. In various embodiments, the sample container is positioned between the electrodes as described herein. In various embodiments, the system includes a second polarizer. The second polarizer can be the same as different as the first polarizer. In various embodiments, the detector includes at least one photodiode. Other detectors, such as the photodetectors described herein, can also be used instead of or in addition to at least one photodiode.

### Electrokinetics and Magnetokinetics Of Particles

The induced dipole of a prolate ellipsoidal particle suspended in a fluid can be modelled using the Maxwell-Wagner interfacial polarization model for ellipsoidal particles.

$${p}_{‖} = 3 {ε}_{f} {V}_{0} {E}_{‖ \vert} Re \{ {\underline{K}}_{‖} \} . \qquad ( 1 )$$

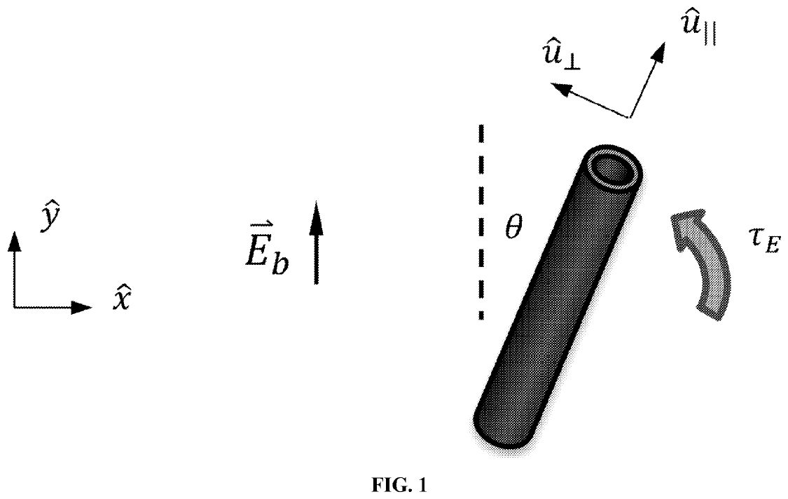

Here, p_{∥} is the dipole induced in the particle along the principal axis, ε_{ƒ} is the permittivity of the fluid, V₀ is the volume of the ellipsoid, and E_{∥}=E cos θ is the strength of the electric field parallel to the principal axis of the ellipsoid, and θ is the angle between the particle and the E-field. The function Re{ } is the real part of the complex input, with complex variables denoted in this thesis with an underline. These variables can be seen defined in FIG. 1.

The Clausius-Mosotti factor K is a complex number which quantifies the polarizability of the ellipsoid. Its component along the principal axis K_{∥} is defined

$${\underline{K}}_{‖} = \frac{1}{3} {( {( \frac{{\underline{ε}}_{p}}{{\underline{ε}}_{f}} - 1 )}^{- 1} + {L}_{‖} )}^{- 1} . \qquad ( 2 )$$

Here, L_{∥} is the depolarization factor of the ellipsoid along the principal axis and ε_{∥,p}=ε_{ƒ,p}+σ_{ƒ,p}/jω is the complex permittivity of the fluid and particle, respectively, and j is the imagionary number. The complex permittibity captures polarizability from both dielectric and charge conduction effects for an AC E-field oscillating at angular frequency ω. As the frequency varies, K_{∥} varies, characterized by two real limits K_{LF} and K_{HF} with a transition frequency ω*=1/τ_{MW}. The Maxwell-Wagner time constant τ_{MW} is defined as

$${τ}_{M W} = \frac{( 1 - {L}_{‖} ) {ε}_{f} + {L}_{‖} {ε}_{p}}{( 1 - {L}_{‖} ) {σ}_{f} + {L}_{‖} {σ}_{p}} . \qquad ( 3 )$$

Specifically if ω«τ_{MW} then

$${\underline{K}}_{‖} \approx {K}_{L F} = \frac{1}{3} {( {( \frac{{σ}_{p}}{{σ}_{f}} - 1 )}^{- 1} + {L}_{‖} )}^{- 1} , and if$$

$$ω ≫ 1 / {τ}_{M W} then {\underline{K}}_{‖} \approx {K}_{H F} = \frac{1}{3} {( {( \frac{{ε}_{p}}{{ε}_{f}} - 1 )}^{- 1} + {L}_{‖} )}^{- 1} .$$

For prolate ellipsoids the depolarization factor has an analytical solution written here as a function of the ellipsoid aspect ratio α and eccentricity e_{cc}=\sqrt{1−α⁻²}.

$${L}_{‖} = \frac{1}{2 {α}^{2} {e}_{c c}^{3}} ( - 2 {e}_{cc} + ln \frac{1 + {e}_{c c}}{1 - {e}_{c c}} ) . \qquad ( 4 )$$

Also, for high-aspect-ratio particles the depolarization factor has a convenient approximation, with less than 1.6% error for α>10.

$${L}_{‖} \approx {α}^{- 2} ( ln 2 α - 1 ) . \qquad ( 5 )$$

From this analysis, one can see that there exists an electrostatic torque on the induced dipole along the principal axis τ_{∥}=p_{∥}û_{∥}× [symbol] . There is also an induced dipole along the minor axis which can be modeled in a similar way as Equations 1-3 above, yielding a torque τ_{⊥}û_{⊥}× [symbol] , with all of the analysis above applying in a similar fashion, except the depolarization factor is defined L_{⊥}=(1−L_{∥})/2. Thus the total torque on the particle is

$${τ}_{E} = {τ}_{‖} + {τ}_{⊥} = 3 {ε}_{f} {V}_{0} {E}^{2} sin θ cos θ Re \{ {\underline{K}}_{‖} - {\underline{K}}_{⊥} \} . \qquad ( 6 )$$

This can instead be expressed as an electrostatic potential

$$Φ = {\int }_{0}^{θ} {τ}_{E} d θ ,$$

and, for an ellipsoidal particle, Φ can be expressed without any assumptions as

$$Φ = \frac{1}{2} {ε}_{f} {V}_{0} {E}^{2} {sin}^{2} θ \cdot Re \{ \frac{{L}_{⊥} - {L}_{‖}}{( {( \frac{{\underline{ε}}_{p}}{{\underline{ε}}_{f}} - 1 )}^{- 1} + {L}_{‖} ) ( {( \frac{{\underline{ε}}_{p}}{{\underline{ε}}_{f}} - 1 )}^{- 1} + {L}_{⊥} )} \} . \qquad ( 7 )$$

The torque on the ellipsoid would therefore be τ_{E}=−∂Φ/∂θ.

One sees from Equation 7 that if the particle is much more polarizable than the surrounding medium, i.e., ∥εₚ∥»∥ε_{f}∥, then K_{∥}→⅓ L_{∥}, which is O(α²/In α) and can be quite large for high-aspect-ratio particles. On the other hand, if the particle is much less polarizable than the surrounding media, then ∥εₚ∥«∥ε_{f}∥ and K_{∥}→(1−3_{∥})/3 (1−L), which is O(1) for high-aspect-ratio particles. So particles that are more susceptible than the surrounding media have the potential to experience a much stronger dipole than particles that are less susceptible than the surrounding media.

For this case, one can simplify Equation 7 with some assumptions. First, one can consider the polarization along the minor axes. Specifically polarization in the direction of the minor axes would decrease the overall torque on the ellipsoid by multiplying by the factor u, which is seen not to be a function of the orientation of the CNT.

$$u = \frac{( {L}_{⊥} - {L}_{‖} ) Re \{ ( {( \frac{{\underline{ε}}_{p}}{{\underline{ε}}_{f}} - 1 )}^{- 1} + {L}_{‖} ) \}}{Re \{ ( {( \frac{{\underline{ε}}_{p}}{{\underline{ε}}_{f}} - 1 )}^{- 1} + {L}_{‖} ) ( {( \frac{{\underline{ε}}_{p}}{{\underline{ε}}_{f}} - 1 )}^{- 1} + {L}_{⊥} ) \}} . \qquad ( 8 )$$

For high-aspect-ratio particles, L_{⊥} can be approximated as ½, and for highly conducting particles, (εₚ/ε_{f}−1)⁻¹→0. Therefore u deviates from unity by O(α⁻² In α), and can be neglected from the analysis pertaining to these CNTs, which have aspect ratios well above 100. Thus, Equation 7 can be simplified to

$$Φ = \frac{π {ε}_{f} {L}^{3} {E}^{2} {sin}^{2} θ}{12 ( ln \frac{2 L}{d} - 1 )} . \qquad ( 9 )$$

Here L is the length of the ellipsoid and d is the diameter of the ellipsoid. Additionally, analysis for conductive cylindrical particles can be made with few additional assumptions, yielding

$${\underline{K}}_{‖ , cyl} = \frac{2 {α}^{2}}{9 ( ln 2 α - 1 )} ( 1 + \frac{4 / 3 - ln 2}{ln 2 α - 1} ) . \qquad ( 10 )$$

Likewise, the potential function of a conducting cylinder is

$$Φ = \frac{π {ε}_{f} {L}^{3} {E}^{2} {sin}^{2} θ}{12 ( ln \frac{2 L}{d} - 1 )} ( 1 + \frac{4 / 3 - ln 2}{ln \frac{2 L}{d} - 1} ) . \qquad ( 11 )$$

The energy associated with the alignment is a convenient way to quantify the electrokinetic effects, so one can define U as the difference in potential energy between a particle aligned parallel with the applied E-field and one aligned parallel with the field, i.e.,

$$U = Φ {\vert}_{θ}^{π / 2} .$$

### Therefore

$$Φ = U {sin}^{2} θ \qquad ( 12 )$$

and the theoretical alignment potential energy by the Maxwell-Wagner polarization model is

$${U}_{MW} = \frac{π {ε}_{f} {L}^{3} {E}^{2}}{12 ( ln \frac{2 L}{d} - 1 )} ( 1 + \frac{4 / 3 - ln 2}{ln \frac{2 L}{d} - 1} ) . \qquad ( 13 )$$

Under this induced electrostatic potential, CNTs will rotate into alignment with the electric field at a rate balancing the alignment torque τ_{E}=−∂Φ/∂θ and the viscous friction torque τ_{ν}=−ζᵣ\dot{θ} where the rotational friction constant ξᵣ for a cylinder rotating in a fluid of viscosity μ is

$${ζ}_{r} = \frac{πμ {L}^{3}}{3 ( ln \frac{L}{d} - 0.8 )} \qquad ( 14 )$$

Combining Equations 13 and 14 to achieve the angular velocity of the rotating particle yields:

$$\dot{θ} = - \frac{{ε}_{f} {E}^{2} sin 2 θ}{4 μ} F ( α ) . \qquad ( 15 )$$

Here F(α) is only a function of the CNT aspect ratio:

$$F ( α ) = ( 1 + \frac{4 / 3 + ln 2}{ln 2 α - 1} ) \frac{ln α - 0.8}{ln 2 α - 1} . \qquad ( 16 )$$

The angular dependance in Equation 15 yields the following relationship between θ and t, the elapsed time, t:

$$tan θ = {e}^{- 2 Ω t} tan {θ}_{0} . \qquad ( 17 )$$

Here θ₀ is the initial angle of the nanotube, and Ω is the maximum alignment rate, which occurs when θ=45°.

### Experimentally Measuring the Electrostatic Polarization of CNTs

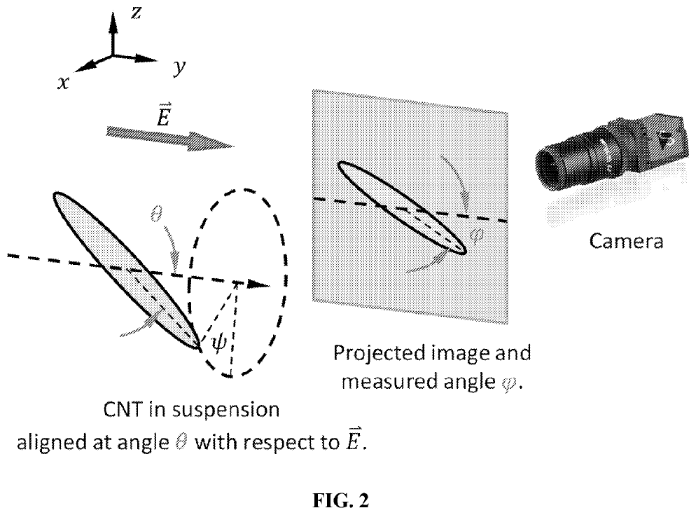

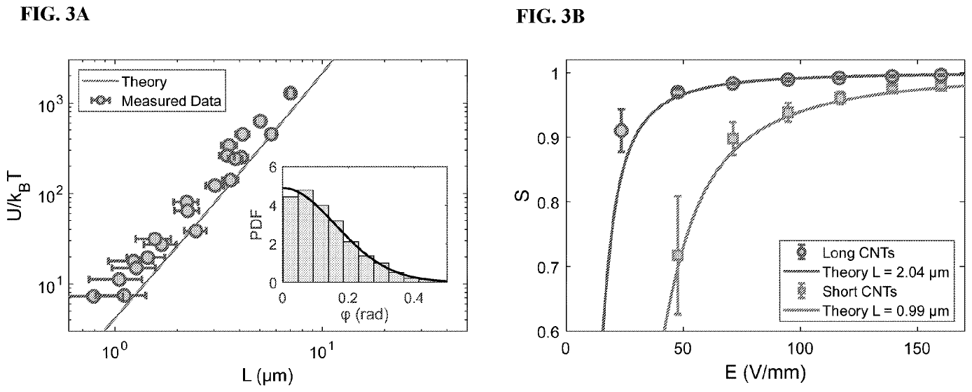

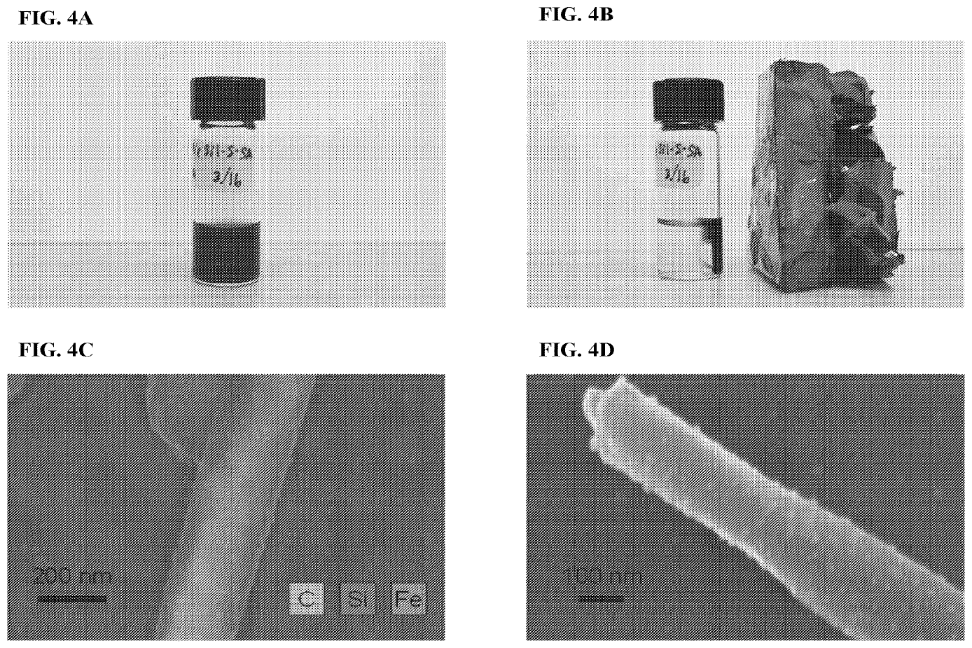

The polarization and alignment kinetics of CNTs was first investigated by studying large, easy-to-visualize multiwall carbon nanotubes. NanoAmor CNTs (Nanostructured & Amorphous Materials, Inc., stock #1238YJS, L=0.5−2 μm, d=30−50 nm) were suspended in a 1:1 mixture of an aliphatic urethane acrylate Laromer UA9033 and dichloroethane (DCE), a solvent. These CNTs were dispersed with tip sonication and placed on the microscope in an electrode setup seen in FIG. 2A.

The degree of alignment of the CNTs at a given field strength can also be observed by watching them fluctuate in alignment angle due to thermal energies over time. These fluctuations will occur according to the Maxwell-Boltzmann distribution of alignment angle with respect to the alignment energy U.

$${P}_{θ} ( θ ) = {c}_{0} exp ( - \frac{U}{{k}_{B} T} {sin}^{2} θ ) sin θ . \qquad ( 18 )$$

Here c₀ is a normalization constant such that

$${{\int }_{0}}^{π / 2} {P}_{θ} ( θ ) d θ = 1 .$$

### Explicitly,

$${C}_{0} = \frac{\sqrt{\frac{U}{{k}_{B} T}}}{D ( \sqrt{\frac{U}{{k}_{B} T}} )} \qquad ( 19 )$$

where D(x) is Dawson's integral. However, it was noted that instead of directly measuring the angle between the nanotube and the electric field, the microscope actually measures φ, the angle projected on the image plane as demonstrated in FIG. 2. Therefore, let us consider the calculations necessary to convert from the probability distribution of θ to the probability distribution of . Because φ is a 2D projection of the angle θ, in general φ≤θ. Without loss of generality, one can assume all angles presented in this analysis do not extend past the domain

$$[ 0 , \frac{π}{2} ] .$$

One can define a third angle ψ to as the longitudinal angle describing the position of a nanotube for a given θ, depicted in FIG. 2. Assuming the center of the suspended nanotube is located at the coordinate origin, the tip of the nanotube will be located at

$$( x , y , z ) = ( \frac{L}{2} sin θ sin ψ , \frac{L}{2} cos θ , - \frac{L}{2} sin θ cos ψ ) .$$

Thus, the y−z projection will put the tip of the projected nanotube at

$$( y , z ) = ( \frac{L}{2} cos θ , - \frac{L}{2} sin θ cos ψ )$$

and therefore

$$tan φ = tan θ cos ψ . \qquad ( 20 )$$

To get the probability distribution of φ, first one can hold θ constant and look at the dependence between ψ and φ. This will allow us to calculate a probability distribution of φ, with θ as an independent variable. Call this probability distribution P_{φ}(φ, θ). It can be assumed that ψ has uniform distribution, P_{ψ}=2/π. From the statistical equation relating the probability distribution of dependent variables P_{φ}(φ, θ)dφ=P_{ψ}d_{ψ} and with dφ/dψ=cos² φ tan θ sin ψ one can see that

$${P}_{φ} ( φ , θ ) = \frac{2}{π {cos}^{2} φ \sqrt{{tan}^{2} θ - {tan}^{2} φ}} . \qquad ( 21 )$$

Next, one can release θ from being held constant, noting that each nanotube with alignment angle θ≥φ will contribute to the probability that the observed angle is φ. Thus the probability that a CNT will be observed at a given angle φ can be expressed by the following singular integral.

$${P}_{φ} ( φ ) = \frac{2}{π {cos}^{2} φ} {\int }_{φ}^{π / 2} \frac{{P}_{θ} ( θ )}{\sqrt{{tan}^{2} θ - {tan}^{2} φ}} d θ \qquad ( 22 )$$

This was derived independently of the Maxwell-Boltzmann distribution seen in Equation 18, so Equation 22 applies to any probability distribution P_{θ}(θ) with the sole condition that ψ has a uniform distribution. Instead of these exact integrals, the small-angle approximation can be applied to Equation 18 and the integral of Equation 23 yielding a closed form solution with under 5.7% error for U/k_{B}T >10

$${P}_{φ} ( φ ) \approx 2 \sqrt{\frac{U}{π {k}_{B} T}} exp ( - \frac{U}{{k}_{B} T} {φ}^{2} ) \qquad ( 23 )$$

### EXAMPLES

Various embodiments of the present application can be better understood by reference to the following Examples which are offered by way of illustration. The scope of the present application is not limited to the Examples given herein.

### Length Distribution Measurement

### 1.1 Technique

Measuring the length distribution of high-aspect-ratio particles like SWNTs is quite difficult. While SEM, TEM and AFM are effective for measuring sub-micron nanotubes, they are tedious for long tubes (i.e. L>5 μm) of high aspect ratio (i.e., a >5000) because of the simultaneous constraints on the resolution and image-window size. Additionally, for longer CNTs, the suspensions are necessarily dilute to observe individual CNTs or CNT bundles, so imaging cannot reveal robust statistics. Size-exclusion chromatography can also be used to characterize CNT length, and even separate CNTs based on their lengths, although the results from size exclusion alone are not quantitative and must typically be calibrated against other measurements techniques like AFM. Centrifugation has also been used to separate CNTs based on their length, but the process is highly sensitive to the solvent or surfactant used and is also sensitive to CNT diameter. Therefore, there is a need for a robust technique to extract length statistics for large-aspect-ratio particles of few-micron length. In particular, for the present purposes, knowledge of the CNT length distributions is needed to choose nanotubes and optimize their processing to ensure that a significant fraction of them are long enough to span the membrane thickness.

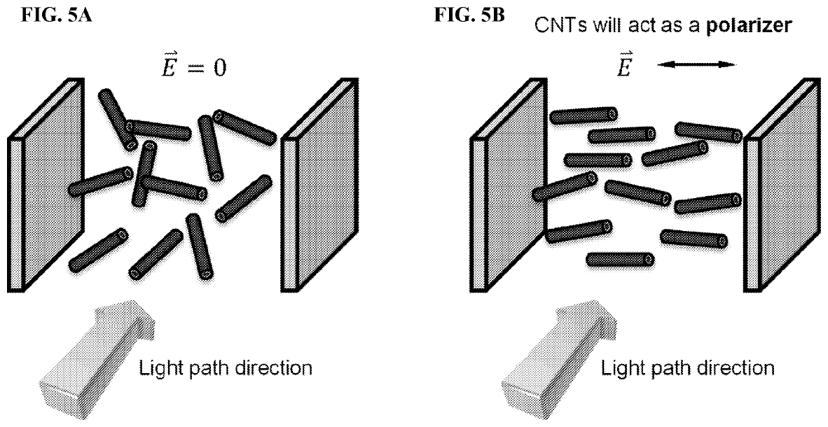

A new length-measurement technique was developed based on the optical-dichroism modulation of CNT suspensions subject to electric fields of different strengths. The basics of the technique are similar to liquid crystal displays (LCDs) in the sense that particles are aligned with an E-field and impact the absorption of polarized light. A schematic of the technique can be seen in FIG. 5. Without the application of an E-field, the CNTs in suspension are randomly aligned, and absorb photons equally, regardless of their polarization, as in FIG. 5A. When an E-field is applied as in FIG. 5B, the CNTs align horizontally, and will absorb horizontally polarized photons more than vertically polarized photons (similar to a polarizer), in a phenomenon is known as dichroism.

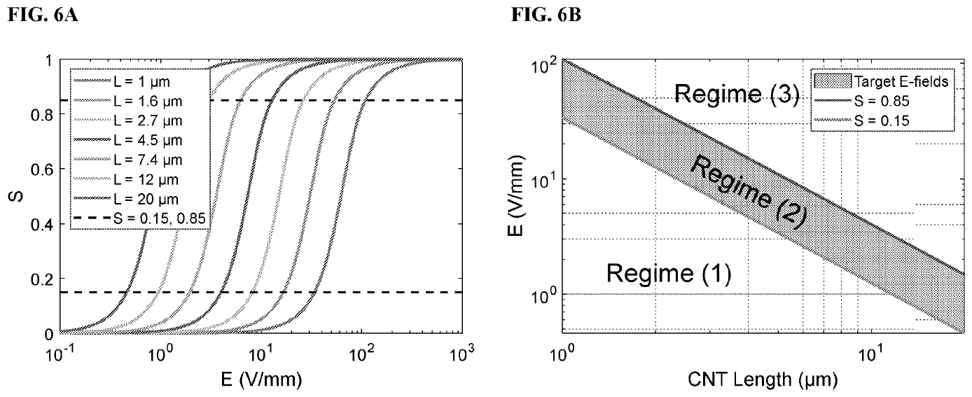

The key to length-distribution determination is that there are three regimes for the dichroism signal: In regime (1) for weaker E-fields, the CNTs will have a low degree of alignment due to thermal (Brownian) fluctuations, resulting in small dichroism. In regime (2) for stronger E-fields, CNTs will have a high degree of alignment and a strong resulting dichroism that increases in magnitude as the E-field increases. In regime (3) for even stronger E-fields, the CNTs will all have a very high degree of alignment, and the dichroism magnitude will reach begin to saturate. The alignment order parameter S, which takes on a value of 0 for random alignment and 1 for perfect alignment with the E-field, can be used to quantify the degree of alignment. Theoretical curves for the degree of alignment as a function of nanotube length and E-field strength are graphed in FIG. 6A for 0.8 nm diameter CNTs in dichlorobenzene (DCB) at room temperature. In practice, to reliably measure particles of a given length, the range of applied E-fields should cover regime (2) and extend into regime (1) and regime (3). Specific values of such E-fields are given in FIG. 6B, again for 0.8 nm CNTs in DCB. The experiments on the degree of alignment of individual CNTs described herein confirmed the use of a theoretical model to predict CNT alignment based on the ratio of alignment potential energy to thermal energy, or U/k_{B}T. Here one can use that model, and the measured polarization absorption anisotropy of CNT suspensions subject to different E-fields, to calculate the length distribution of the CNTs.

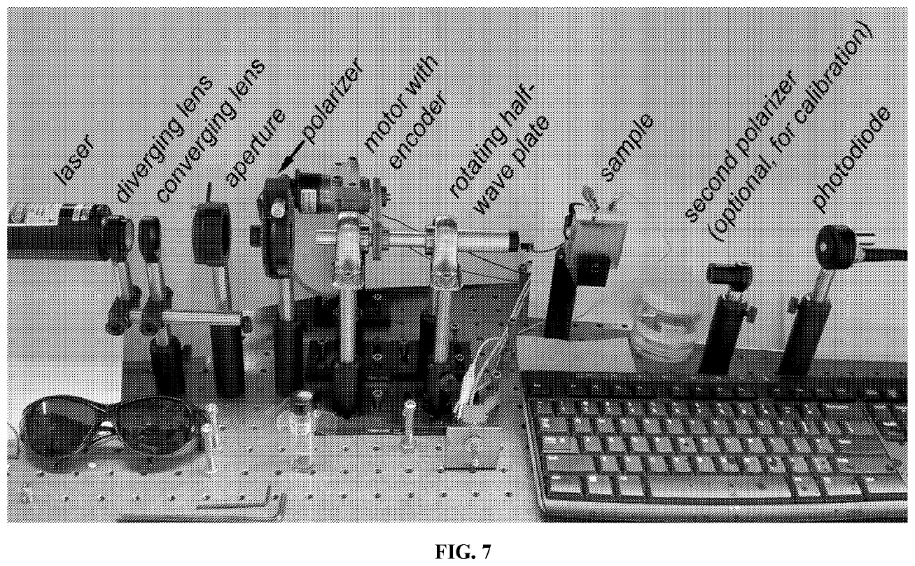

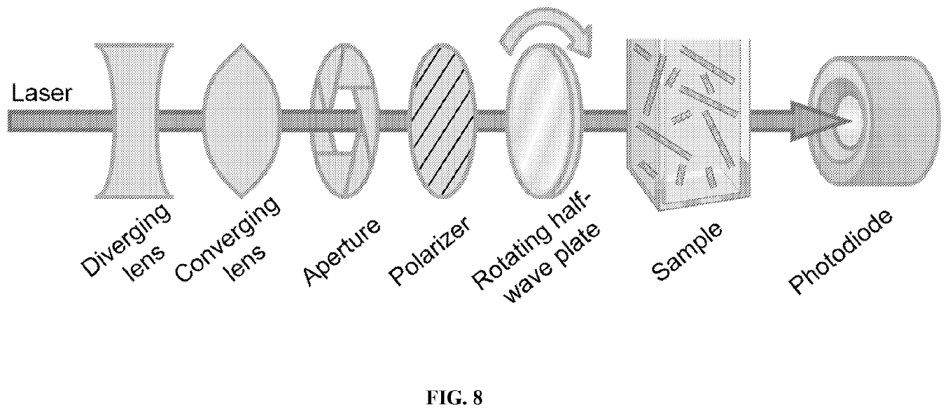

An experimental setup modeled after previous systems was constructed to measure the dichroism response of CNT sample, as seen in FIG. 7 and FIG. 8. From left to right, a 632 nm He—Ne laser produced the linearly polarized light. The laser was allowed to warm up for 20 minutes to stabilize the laser intensity prior to beginning any measurement. Next, a confocal diverging/converging lens pair was used to expand the laser beam so that it could cover the photodiode detector area evenly. Additionally, the diverging/converging lens pair could be easily adjusted to steer the beam. An aperture was placed next in the laser path and adjusted so that the laser light did not fall on the metal electrode surfaces, which could cause small-angle reflections that could change the polarization of the transmitted light. Next, a Glan-Taylor polarizer with a 106 extinction ratio was placed in the laser path.

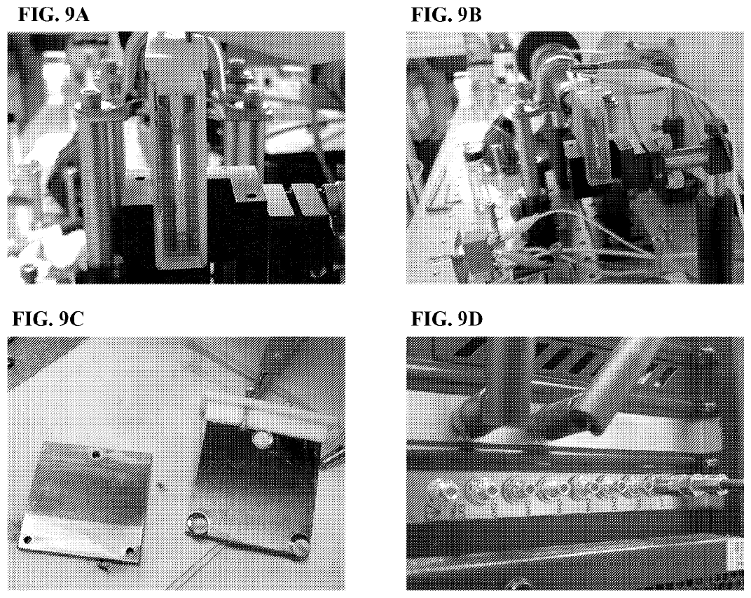

This polarizer increased the degree of polarization of the light, and could also be rotated such that the relative angle between the Glan-Taylor polarizer and the polarized laser could be used to control the beam intensity. Next, a motor connected to an encoder was used to drive a half-wave plate at 1800 rpm. This rotated the light polarization at 3600 rpm or 60 Hz. Because CNTs absorb polarized light with 180° symmetry, the resulting dichroism signal oscillated at 120 Hz. Next the laser passed through the CNT solution in a 4-cm-path-length cuvette between a pair of parallel-plate stainless-steel electrodes spaced 2.24 mm apart. Images of the laser passing through the sample can be seen in FIGS. 9A and 9B, and the disassembled electrodes can be seen in FIG. 9C. A vertically oriented polarizer could be introduced into the laser-beam path for calibration, although during experiments this polarizer was kept out of the laser path. Lastly, the transmitted beam reached the photodiode detector where it was converted into an electrical signal sent to the computer.

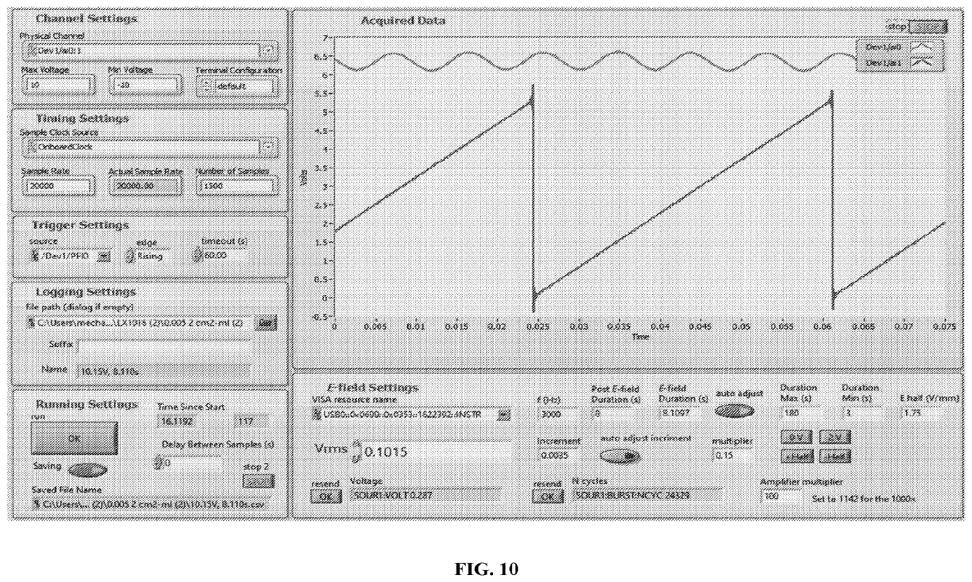

Data was taken using a National Instrument DSA-4472 digital lock-in amplifier, which simultaneously recorded the optical signal and the signal from the motor encoder. The front panel of a custom LabVIEW program to record the signals is shown in FIG. 10. An image of the card can be seen in FIG. 9D with SMB cables connected to the analog voltage inputs. A voltage was applied to the CNT sample through the parallel-plate electrodes by connecting a function generator (Tektronix Inc., model AFG1000) to a high-voltage amplifier (TREK, Inc., model PZD350 M/S). Defined voltage pulses were triggered by a timing box (BNC Precision, model 555). The timing box was also connected to the DSA lock-in amplifier so that data acquisition was able to start 0.5 s before the application of the E-field.

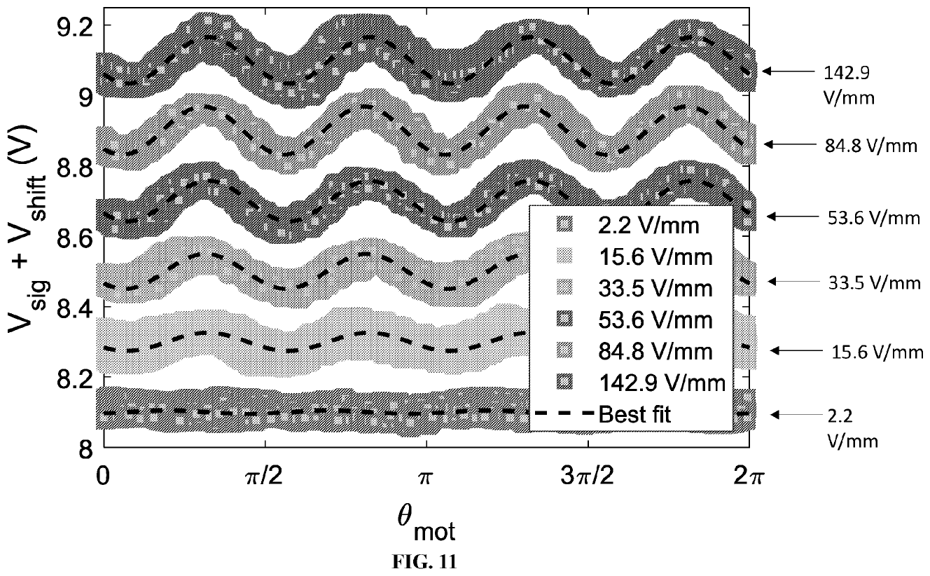

Images of the dichroism signal itself, after the CNTs had reached steady-state alignment, can be seen in FIG. 11. To create this graph, each recorded data point for the photodiode voltage, V_{sig}, was plotted against the angle of the motor encoder, θₘₒₜ, which was taken as an angle between 0 and 2π. The collapse of the data from over 60 periods onto a single sine wave demonstrates the robustness of the recorded signal. For better visibility, each signal after the first was shifted by an arbitrary voltage V_{shift}. Plotted in this fashion, the signature of dichroism is evident; the signal frequency is four times the motor frequency. The Fourier transform of the recorded signal was used to extract the signal amplitude at this frequency, and that voltage amplitude is referred to as the dichroism signal.

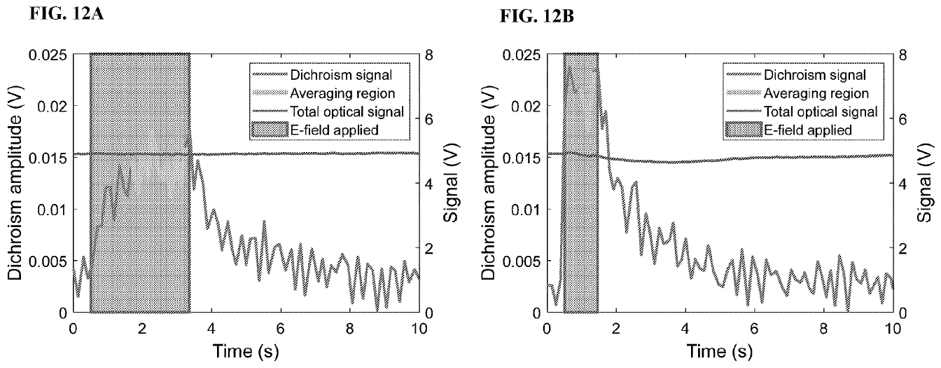

The dichroism amplitude calculated by the Fourier transform can be seen graphed over time in FIGS. 12A and 12B for two different voltages applied to a CNT sample. While the total optical signal is ~5 V in this figure, the dichroism is only ~0.02 V. Nevertheless, the measurement is accurate enough to resolve the increase in the dichroism signal that correlated with the application of the electric field. For weaker fields for which the CNTs take longer to align, as in FIG. 12A, the E-field was applied for a few seconds to allow for the CNTs to reach a steady state degree of alignment. For stronger electric fields, as in FIG. 12B the E-field was only applied for one second because the CNTs rapidly reach steady state and prolonged durations of the E-field could be detrimental to the solution stability. As discussed herein, the rate of alignment is independent of particle length and aspect ratio, so the rate of alignment is

$${\dot{θ}}_{max} = \frac{{ε}_{f} {E}^{2}}{4 μ} . \qquad ( 58 )$$

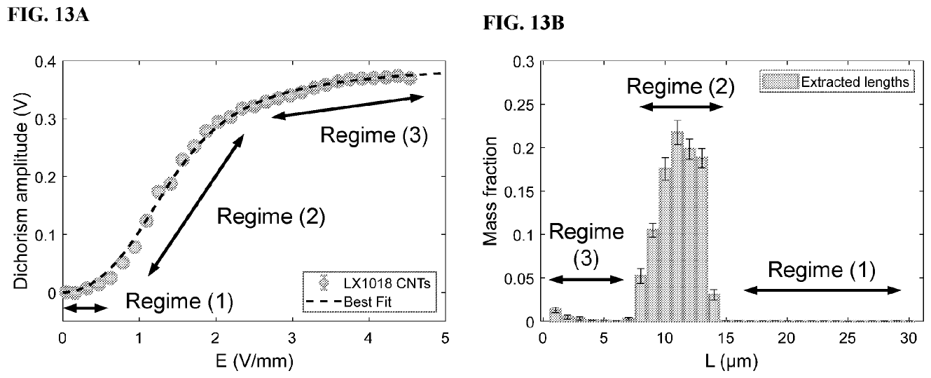

Practically, the E-field was applied for a duration of at least

$$5 \frac{π / 2}{{\dot{θ}}_{m α x}} ,$$

where the factor of 5 is an empirically determined factor so that the steady-state value could be easily observed. Once steady state was achieved, the data in the green region seen in FIG. 13 was averaged together to produce data for that value of the applied voltage.

By varying the applied voltage and measuring the resulting dichroism amplitude, one can create the dichroism modulation graphs, an example of which can be seen in FIG. 13A. From this graph, the different responses can be identified as: regime (1) at low E-fields before the dichroism signal increases, regime (2) where the dichroism amplitude increases as the applied E-field increases, and regime (3) where the dichroism amplitude levels off as the E-field is increased. The values of the E-field magnitude for each these three regimes can be used to extract the particle length distribution. The overall magnitude of the dichroism does not have an effect on the extracted particle lengths. For any given experiment, the E-field was increased until the dichroism amplitude was observed to reach its saturation value, and sufficient E-fields were probed to capture many data points in each of the three regimes described above.

To extract the particle-length distribution from the measured dichroism response, a fitting algorithm was developed. The fitting had a large number of adjustable parameters, namely the relative fraction of particles of each length. In various embodiments, to address the uniqueness of the solutions, the following procedure was developed:
1. A set of trial lengths was defined, and theoretical curves for the resulting dichroism response were calculated.
2. Random values for the signal intensity of all of the trial lengths were taken as the initial value, constrained such that the total of all signal intensities was 1.
3. An iteration is defined as a single refinement for each of the trial lengths. For each iteration, the lengths were put into a random permutation, and for each length the signal intensity was adjusted. For a given length, the signal intensity was adjusted over nine intervals varying linearly from −ΔI to ΔI, with ΔI taking an initial value of 0.1. For each trial intensity, the linear combination of the dichroism response from all of the lengths was calculated, and the trial intensity with the minimum squared error from the experimental measurements was selected.
4. The value of ΔI was refined to 90% of its previous value. The small refinement aided in the robustness of the fitting progression.
5. Steps 3 and 4 were iterated on 30 times, converging on a solution with minimal error.
6. Steps 1 through 5 were repeated 9 times to evaluate the robustness of the algorithm and the uniqueness of the solution. The results of all nine solutions were averaged together, with the standard deviation giving the error bars seen on the calculated length histograms.

An important consideration for the dichroism method is sample stability. As noted previously, the E-field was applied only as long as necessary to measure the steady-state dichroism amplitude at that field strength. Nevertheless, the stability of the particle suspension was evaluated by measuring the dichroism response as the E-field was first increased, and then decreased. This allows for observation of several phenomena: If the dichroism amplitude is observed to decrease in magnitude over time at the same value of the E-field then that could indicate particle settling. If the dichroism amplitude in regime (2) for decreasing voltages is higher than for increasing voltages, then this may indicate particle chaining which would be observed as longer particles. Observing no or minimal signal hysteresis would rule out these adverse phenomena. Only samples which were observed to have no hysteresis are presented here.

An example of the dichroism response from LX1018 CNTs at a concentration of 5×10⁻⁵ g/L can be seen in FIG. 13. The features of FIG. 13A and FIG. 13B have a direct correspondence as follows: The slight slope in the section indicated as regime (3) results in the modeled content of shorter CNTs 1-4 μm in length in FIG. 13B. There is also a sharp interface which defines regime (2) as the region where the dichroism amplitude has the greatest slope in FIG. 13A. The E-fields that correspond to this region, ~1-2 V/mm, directly correspond to the length peak in FIG. 13B at lengths of 9-13 μm. This one-to-one correspondence is only a function of the particle diameter and suspending fluid, in this case 0.8 nm diameter CNTs in DCB.

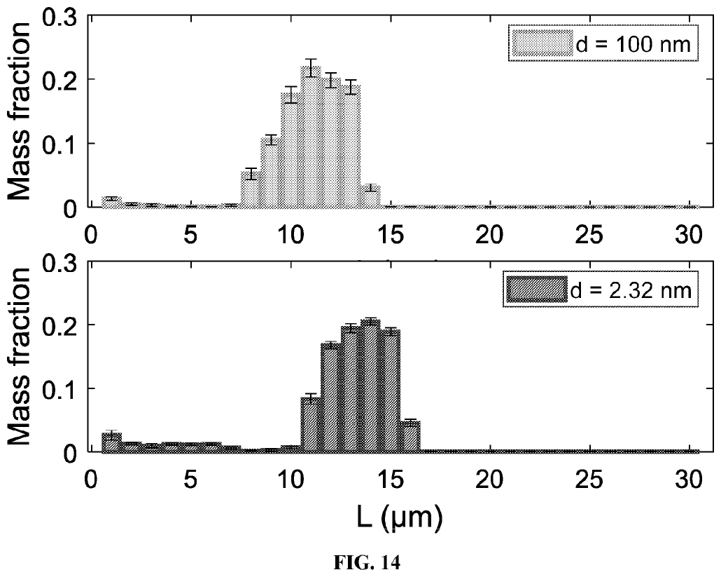

In broad terms the CNT polarization scales as L³/In α (the exact scaling is shown in Equation 13, so the assumed particle diameter does not have a large contribution to the extracted length. For example, the dichroism signal in FIG. 13A was fit twice, first using an assumed diameter of 100 nm and then again assuming 2.02 diameter, corresponding to CNT bundles and individual CNTs, respectively. The two resulting length distributions can be seen in FIG. 14. For the smaller assumed diameter, longer tubes are needed to achieve the same degree of polarization under an E-filed, so the extracted length distribution is longer. Nevertheless, for a 50× drop in diameter (from 100 nm to 2.02 nm), the average extracted length only increased from 11.2 μm to 13.5 μm, a 21% change. Therefore, the particle diameter does not have a large impact on the extracted length by the polarization technique. Furthermore, the simplified scaling formula U∝L³/In α would predict a 24% change in the measured length for such a decrease in the assumed diameter, and therefore does a good job at predicting how the length dependence would be affected by modifying the assumed particle diameter.

### 1.2 Validation

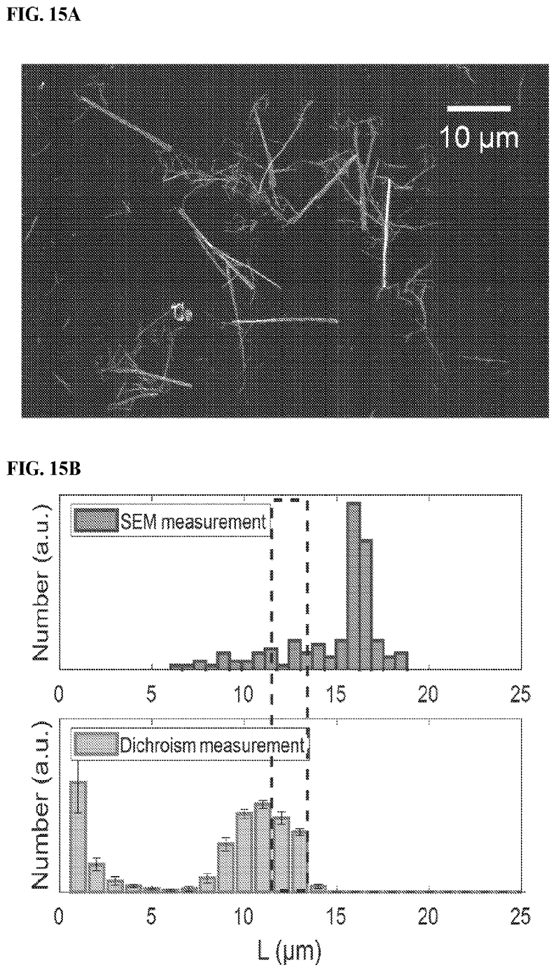

To validate the dichroism measurement of particle lengths, three particles were examined with the technique and optical or SEM visualization. LX1018 CNTs grown to a nearly uniform length at LLNL, quoted to be 12-13 μm long and 2.02 nm in diameter, was first examined. When examined under the SEM as pictured in FIG. 15A, the lengths were extracted to be ~10-18 μm with a very strong peak at 15-17 μm. From the dichroism measurement (discussed in FIG. 13 and FIG. 14 above), the extracted lengths have a mean at 11.2 μm. Although this is slightly shorter than the SEM measurement, the shorter CNT bundles may be underrepresented in the SEM count because they form more tangled agglomerates. Nevertheless, there is overlap in the measured lengths. In order to translate the mass fraction (which is assumed proportional to the dichroism signal voltage) to the number fraction, a constant diameter for long and short particles was assumed so the number fraction for a given length would be proportional to the mass fraction divided by the particle length.

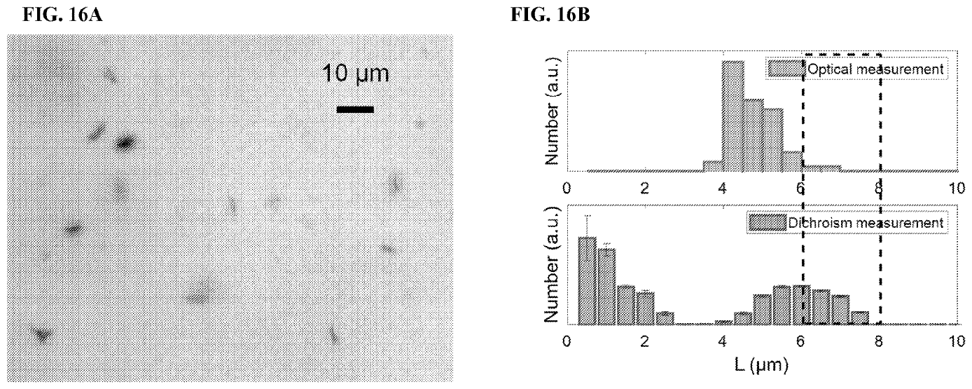

Next, another sample of CNTs from LLNL, grown to a quoted length of 6-8 μm, was tested in the dichroism-measurement setup. An optical image of the LX0710 CNTs can be seen in FIG. 16A. There was minimal hysteresis when the sample was diluted to 7×10⁻⁴ g/L, and extracted lengths with a peak at 6 μm agree very well with the quoted length of the CNTs and with the optical measurement of the CNT lengths. The content of shorter, <2 μm long CNTs detected by the dichroism measurement technique is similar to that of FIG. 15B. In certain embodiments, these short particles, which are present in both samples, are fragments of CNTs that were broken during sonication and too small to observe under the optical microscope.

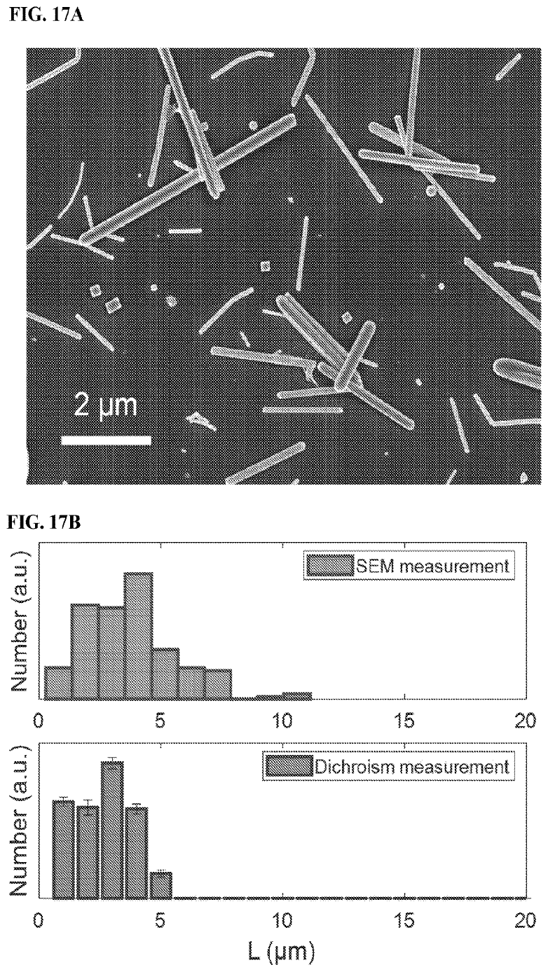

Additionally, Ag nanowires (NWs) were examined under the SEM and with the dichroism technique. For these NWs, the SEM images in FIG. 17A show that most of the nanowires are below 5 μm in length. These nanowires were suspended at 0.003 g/L in hexadecane because of its lower electrical conductivity compared to DCB, which reduced signal noise. These particles have an SEM-measured length that matches quite well with the dichroism-extracted length, further validating the technique.

1.3 Results with CNTs

### Example 1

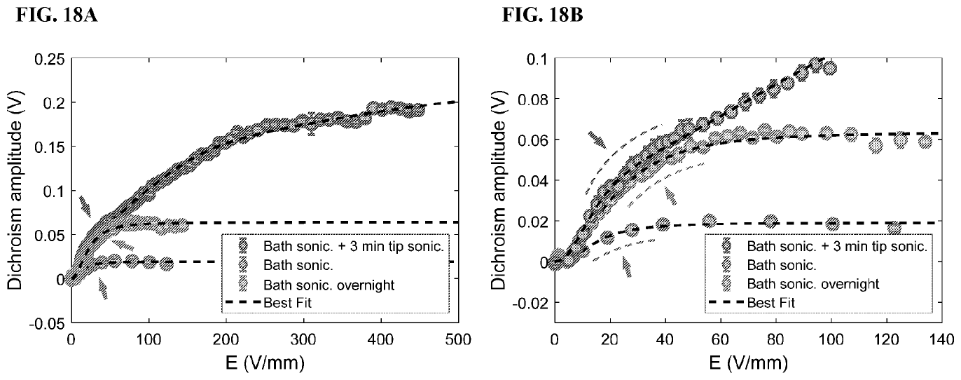

Next, the dichroism length-extraction technique was applied to PXD2-2024 CNTs in DCB. Samples of these CNTs were prepared by creating a suspension of 0.5 g/L of CNT powder in DCB with 15 minutes of bath sonication. Next the suspension was diluted to 0.01 g/L, then diluted again to 0.001 g/L, and finally to 0.0001 g/L with 15 min of bath sonication applied between each dilution step. This produced a sample of 0.0001 g/L CNT suspension that had been bath sonicated for one hour. An aliquot of this sample was taken, then the sample was split and further processed with either overnight bath sonication or 3 min of tip sonication. The sample that had received bath sonication overnight was quite dark and demonstrated strong hysteresis when measured repeatedly, so the sample was diluted to 10-5 g/L, bath sonicated for 15 minutes, and re-measured. The final measurement of the dichroism response no longer revealed hysteresis. The dichroism response for these three samples can be seen in FIG. 18A. Interestingly, for the sample treated with tip sonication, a bump in the dichroism is evident in the 20-40 V/mm range, highlighted in FIG. 18B. These bumps are characteristic of 2-4 μm long particles, as will be discussed later.

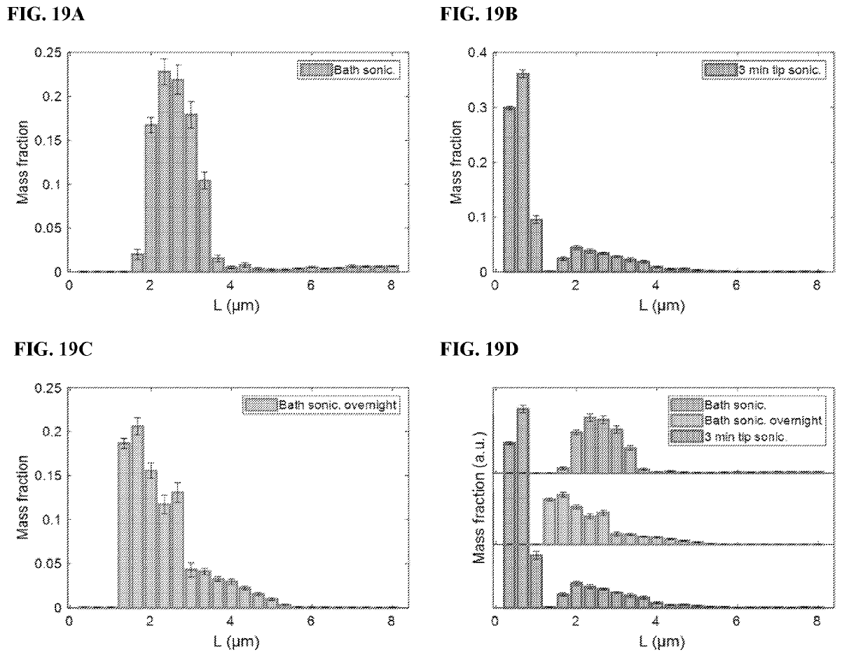

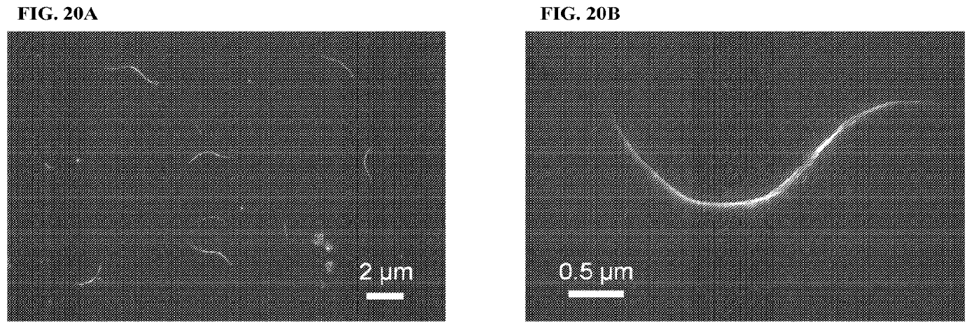

From the dichroism-response graphs, the extracted lengths for each samples treated with different sonication procedures can be seen individually in FIGS. 19A-19C and overlaid together in FIG. 19D. From the overlaid distributions, the length peak at 2-4 μm can be seen in each of the samples. The consistency of the shape of the length distributions in the 2-4 μm range is an indication of the robustness of the length-measurement technique. Furthermore, for the sample treated with 3 minutes of tip sonication, there is a large content of sub-micron CNTs. This is a strong indicator that the CNTs are being broken and shortened by the aggressive sonication, and explains why membranes created with tip-sonicated CNTs underperformed membranes created with bath sonication only. Furthermore, CNT samples in DCE with the same preparation procedure as above were observed dried on Si wafers under the SEM, seen in FIGS. 20A and 20B. The clear content of 2-4 μm long CNT bundles in the SEM images further validates the dichroism measurement.

The length-distribution measurement technique is critical in the production of highly-permeable CNT membranes, because the CNTs must be long enough to span the thickness of the membranes. This technique allows us to identify CNT growths that are the right length for membrane fabrication, and allow us to identify dispersion techniques that preserve the CNT length. For instance, tip sonication applied to 0.8 nm CNTs, while creating quality dispersions, adversely shorten a large mass fraction of the CNTs leaving them too short for membranes to fully benefit from inner-CNT transport, while bath sonication leaves the CNTs significantly longer. Therefore, this technique benchmarks a paramount achievement towards fabricating the most highly permeable membranes with optically-invisible CNTs.

### Example 2

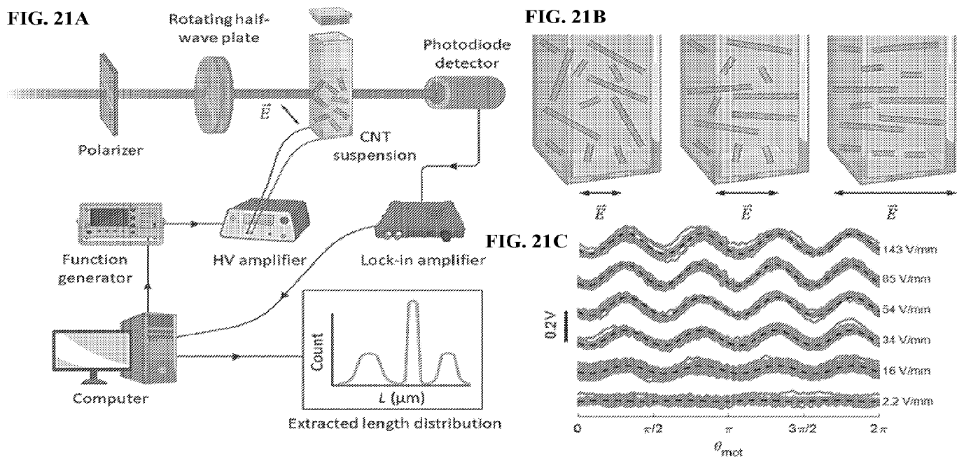

The polarization of electrically susceptible particles is captured by the Maxwell-Wagner interfacial polarization model. This theoretical model has been verified for CNTs, and metallic particles by direct measurement. Here the model was used, combined with the measured degree-of-alignment of suspended particles to extract their length distribution. While weaker E-fields will result in a low degree-of-alignment, stronger E-fields will cause susceptible particles to align with their principal axis parallel to the E-field. FIG. 21B shows that for a weak E-field, particles have a random orientation, while for a medium E-field longer particles will align while shorter particles will be more randomly orientated, and for even stronger E-fields both long and short particles will experience a high degree of alignment. By observing the E-field magnitudes which cause the dichroism to increase and the stronger E-fields which eventually lead to dichroism saturation, it is possible to comment directly on the particle length. The technique is even sensitive enough to properly extract bimodal length-distributions.

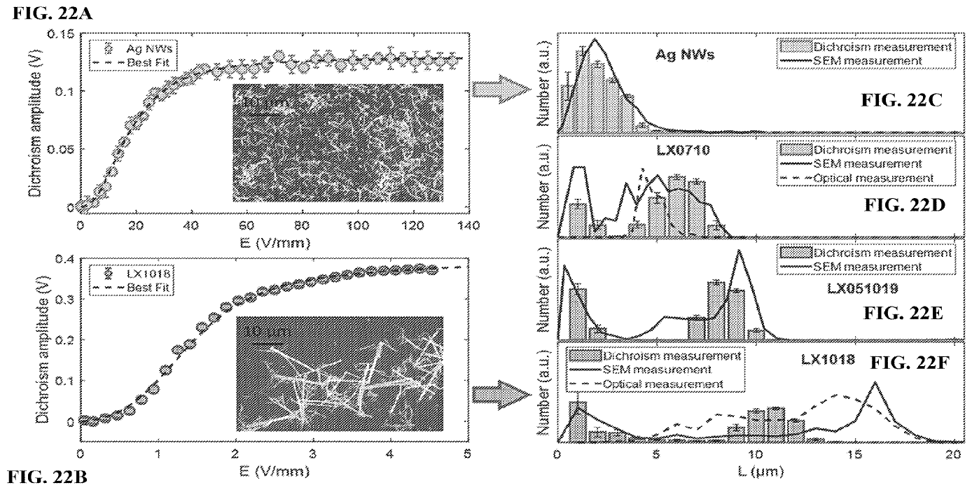

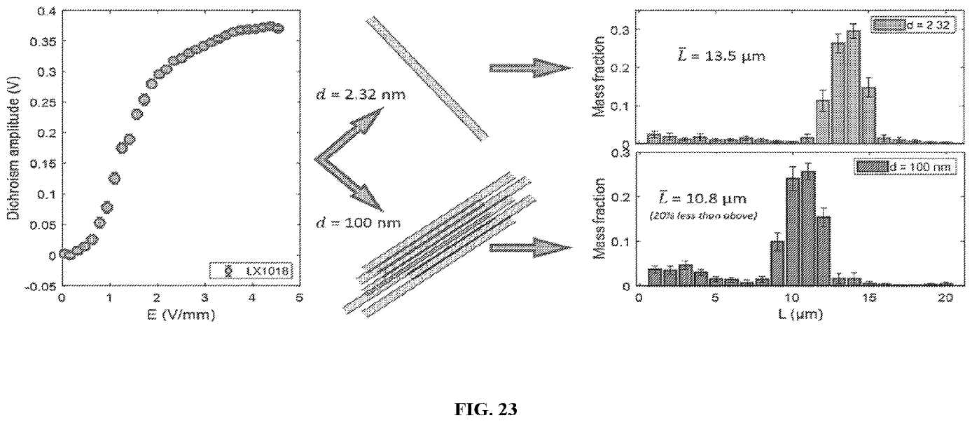

An encoder records the angle of a motor driving the half-wave plate and due to the half-wave plate, the angle of polarization will cycle at twice the motor frequency, and because the aligned particles will absorb light with 180° symmetry, the dichroism signal will oscillate at four times the frequency of the motor. This is observed in FIG. 21C for various magnitudes of the E-field. At E-fields of 2.2 V/mm the dichroism is hardly visible, while the dichroism increases from 16-54 V/mm, the dichroism signal saturates as E increases beyond 54 V/mm. A Fourier transform extracts the dichroism signal magnitude from the photodiode signal traces seen in FIG. 21, and the extracted signal is graphed as dashed lines in FIG. 21. Examples of such dichroism signal responses for silver nanowires and carbon nanotube bundles graphed as a function of the applied E-field can be seen in FIG. 22A and FIG. 22B, along with inset SEM images of the respective particles dried on silicon wafers. Evident in these signal response graphs are three regimes of the response, (1) an initial low magnitude of the dichroism signal amplitude at low E-fields, (2) an increase in the dichroism signal as the E-field increases, eventually leading to (3) a saturation of the dichroism signal at higher E-fields. Each nanoparticle length has a unique response to the applied voltages and will experience regimes 1, 2, and 3 at different values of the E-field, modeled by Eqs. (24) and (25)

The Maxwell-Wagner polarization model predicts that if the particle has a different electrical conductivity σₚ than that of the fluid σ_{f}, or the particle has a different electrical permittivity εₚ than that of the fluid ε_{f} then the particle will become electrically polarized when subjected to an E-field in fluid suspension. This model quantifies the E-field alignment potential energy as the potential energy difference between a particle aligned perpendicular from one aligned parallel to the E-field. This potential energy, U_{MW} is highly dependent on the particle length L, and only slightly influenced by the particle diameter d. For ellipsoidal particles, the potential energy has an analytical solution defined as a function of the complex permittivity of the particle and fluid ε_{p,f}=ε_{f,p}+σ_{j,p}/jω, where ω is the angular frequency of the E-field and j is the imaginary unit.

$${U}_{MW} = \frac{1}{2} π {ε}_{f} {V}_{0} {sin}^{2} θ Re \{ \frac{{L}_{⊥} - {L}_{\vert \vert}}{( ( \frac{{\underline{ε}}_{{}^{p}}}{{\underline{ε}}_{{}^{f}}} - 1 ) + {L}_{\vert \vert} ) ( ( \frac{{\underline{ε}}_{{}^{p}}}{{\underline{ε}}_{{}^{f}}} - 1 ) + {L}_{⊥} )} \} \qquad ( 24 )$$

Here, V₀ is the particle volume, and L_{⊥} are the depolarization factors along the principal axis of the particle and perpendicular to the principal axis, respectively. The ratio of the alignment potential energy to the thermal energy directly controls the probability distribution of the degree of alignment

$$P ( θ ) = \frac{\sqrt{\frac{U}{{k}_{B} T}}}{D ( \sqrt{\frac{U}{{k}_{B} T}} )} exp ( - \frac{U}{{k}_{B} T} {sin}^{2} θ ) sin θ \qquad ( 25 )$$

Where D (x) is Dawson's integral, and without loss of generality θ is constrained to [0, π/2]. And the ensemble average degree of alignment can be quantified by the alignment order parameter S=(3 cos² θ-1)/2, where (·) represents the ensemble average. Explicitly,

$$S = \frac{1}{2} {\int }_{0}^{π / 2} P ( θ ) ( 3 {cos}^{2} θ - 1 ) d θ .$$

The dichroic absorption of suspensions of thin rods is directly proportional to the alignment order parameter.

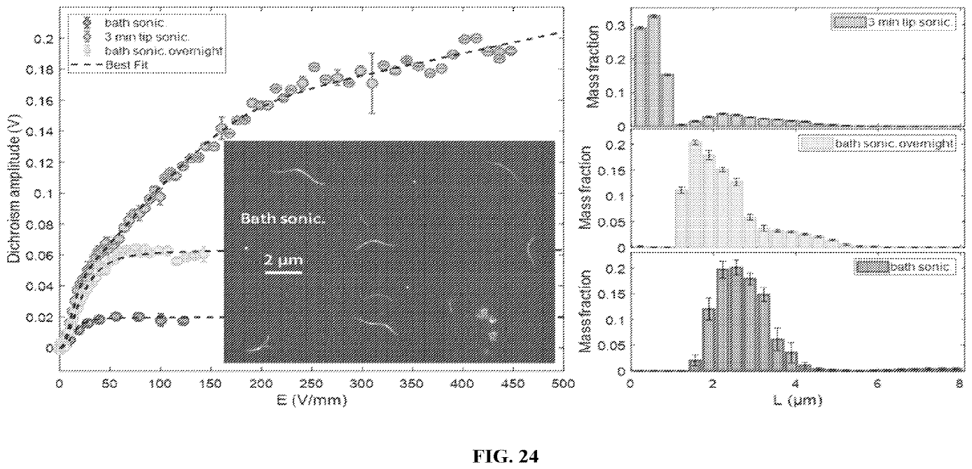

The unique signature of the dichroism response for each individual length allows for the extraction of the length by fitting the dichroism response. FIGS. 22D, 22E, and 22F show that the fitting is precise enough to extract bimodal length distributions and distributions with statistical dispersion. These extracted histograms are compared to SEM visualization, and optical microscopy and, while optical microscopy cannot resolve the shorter lengths, the agreement is quite close between the dichroism technique, SEM, and optical microscopy. Additionally, measuring particle length by E-field polarization also results in a very low sensitivity to particle diameter. The technique utilizes an assumed particle diameter to ensure that the particle length is the only adjustable parameter to fit, and as seen in FIG. 24, large variations in particle diameter only have a slight effect on the extracted length distribution. In fact, modifying the assumed particle diameter from 2.32 nm, (the TEM-measured average individual diameter) to 100 nm, the average bundle diameter only resulted in a reduction of the measured mean length by only 20.4%.

Furthermore, different sonication treatments were compared on the same CNT samples. High power tip sonication at 180 W was compared to two different durations of bath sonication and the resulting length distributions were measured, seen in FIG. 24. This graph demonstrates that when tip sonication is applied to the CNT suspensions in DCB, the CNTs will fractionalize, with 77 wt. % of the CNTs breaking into shorter segments≤1.2 μm. Even so, the remaining 23 wt. % of the CNTs are in a range of 2-5 μm long CNTs. The population of CNTs 2-5 μm long again appears in the CNT samples that were bath sonicated for 1 hour and for 18 hours. This is consistent with the hypothesis that 2-5 μm is the native length of the CNTs in the sample, and that bath sonication, even for extended durations does not fractionalize the CNTs to below this length. The inset of FIG. 24 further demonstrated that SWNT bundles exist in suspension at the measured length.

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### Enumerated Embodiments

The following enumerated embodiments are provided, the numbering of which is not to be construed as designating levels of importance:
Embodiment 1 provides a method of measuring nanowire or carbon nanotube (CNT) lengths, the method comprising: illuminating a sample comprising a plurality of nanowires or CNTs with a polarized laser light source; applying an electric potential to the sample with a plurality of electrodes; and monitoring the sample dichroism amplitude as a function of the electric potential and direction of the polarized laser light to determine the nanowire or CNT lengths in the sample.
Embodiment 2 provides the method of embodiment 1, wherein the plurality of electrodes comprises two parallel plate electrodes.
Embodiment 3 provides the method of any one of embodiments 1-1, further comprising passing laser light from the polarized laser light source through at least one of a diverging lens, converging lens, aperture, polarizer, and rotating half-wave.
Embodiment 4 provides the method of any one of embodiments 1-3, wherein the sample is positioned between the two parallel plate electrodes.
Embodiment 5 provides the method of any one of embodiments 1-4, wherein the sample comprises a nanowire or CNT suspension.
Embodiment 6 provides the method of any one of embodiments 1-5, wherein the CNT or nanowire is about 0.1 to about 15 μm in length.
Embodiment 7 provides the method of any one of embodiments 1-6, wherein the CNT or nanowire has a width dimension that is about 20 to about 10,000 times shorter than the length dimension of the CNT or nanowire.
Embodiment 8 provides the method of any one of embodiments 1-7, wherein the plurality of nanowires comprises at least one of a silver nanowire, a gold nanowire, a copper nanowire, a mixed metal nanowire, a nanowire comprising metal oxides, or a biological nanowire.
Embodiment 9 provides the method of any one of embodiments 1-8, wherein the nanowire is conductive.
Embodiment 10 provides the method of any one of embodiments 1-9, wherein the polarized laser light passes through the sample and into a photodetector.
Embodiment 11 provides the method of any one of embodiments 1-10, wherein the photodetector comprises at least one photodiode.
Embodiment 12 provides the method of any one of embodiments 1-11, wherein the monitoring comprises changing the electric potential applied to the sample and measuring at least one of: a. no increase in the dichroism amplitude; b. a proportional increase in the dichroism amplitude with increasing electric potential; or c. a levelling-off of the dichroism amplitude with increasing electric potential, wherein the changing comprises increasing the potential from about 0 to a maximum potential value or decreasing the potential from a maximum potential value to about 0; and wherein the maximum potential value is determined by observing the electrical potential at which no measurable increase in dichroism amplitude occurs as the electrical potential is increased.
Embodiment 13 provides system for measuring nanowire or carbon nanotube (CNT) length, comprising: a laser light source; a first polarizer; a plurality of electrodes; a sample container through which the laser light passes; and a detector to detect the dichroism amplitude of light passing through the sample container.
Embodiment 14 provides the system of embodiment 13, further comprising at least one of a diverging lens, converging lens, aperture, polarizer, and rotating half-wave plate. Embodiment 15 provides the system of any one of embodiments 13, wherein the sample container comprises nanowires or carbon nanotubes (CNT) in a liquid suspension. Embodiment 16 provides the system of any one of embodiments 13-15, wherein the CNT or nanowire is about 0.1 to about 15 μm in length.
Embodiment 17 provides the system of any one of embodiments 13-16, wherein the CNT or nanowire has a width dimension that is about 20 to about 10,000 times shorter than the length dimension of the CNT or nanowire.
Embodiment 18 provides the method of any one of embodiments 13-17, wherein the plurality of nanowires comprises at least one of a silver nanowire, a gold nanowire, a copper nanowire, a mixed metal nanowire, a nanowire comprising metal oxides, or a biological nanowire.
Embodiment 19 provides the method of any one of embodiments 13-18, wherein the nanowire is conductive.
Embodiment 20 provides the system of any one of embodiments 13-19, wherein the plurality of electrodes comprises two parallel-plate electrodes.
Embodiment 21 provides the system of any one of embodiments 13-20, wherein the sample container is positioned between the two parallel-plate electrodes.
Embodiment 22 provides the system of any one of embodiments 13-21, further comprising a second polarizer.
Embodiment 23 provides the system of any one of embodiments 13-22, wherein the detector comprises a photodiode.

1. A method of measuring nanowire or carbon nanotube (CNT) lengths, the method comprising:
illuminating a sample comprising a plurality of nanowires or CNTs with a polarized laser light source;
applying an electric potential to the sample with a plurality of electrodes; and
monitoring the sample dichroism amplitude as a function of the electric potential and direction of the polarized laser light to determine the nanowire or CNT lengths in the sample.

2. The method of claim 1, wherein the plurality of electrodes comprises two parallel plate electrodes.

3. The method of claim 1, further comprising passing laser light from the polarized laser light source through at least one of a diverging lens, converging lens, aperture, polarizer, and rotating half-wave.

4. The method of claim 2, wherein the sample is positioned between the two parallel plate electrodes.

5. The method of claim 1, wherein the sample comprises a nanowire or CNT suspension.

6. The method of claim 1, wherein the CNT or nanowire is about 0.1 to about 15 μm in length.

7. The method of claim 1, wherein the CNT or nanowire has a width dimension that is about 20 to about 10,000 times shorter than the length dimension of the CNT or nanowire.

8. The method of claim 1, wherein the plurality of nanowires comprises at least one of a silver nanowire, a gold nanowire, a copper nanowire, a mixed metal nanowire, a nanowire comprising metal oxides, or a biological nanowire.

9. The method of claim 1, wherein the nanowire is conductive.

10. The method of claim 1, wherein the polarized laser light passes through the sample and into a photodetector.

11. The method of claim 10, wherein the photodetector comprises at least one photodiode.

12. The method of claim 1, wherein the monitoring comprises changing the electric potential applied to the sample and measuring at least one of:
a. no increase in the dichroism amplitude;
b. a proportional increase in the dichroism amplitude with increasing electric potential; or
c. a levelling-off of the dichroism amplitude with increasing electric potential, wherein the changing comprises increasing the potential from about 0 to a maximum potential value or decreasing the potential from a maximum potential value to about 0; and
wherein the maximum potential value is determined by observing the electrical potential at which no measurable increase in dichroism amplitude occurs as the electrical potential is increased.

13. A system for measuring nanowire or carbon nanotube (CNT) length, comprising:
a laser light source;
a first polarizer;
a plurality of electrodes;
a sample container through which the laser light passes; and
a detector to detect the dichroism amplitude of light passing through the sample container.

14. The system of claim 13, further comprising at least one of a diverging lens, converging lens, aperture, polarizer, and rotating half-wave plate.

15. The system of claim 13, wherein the sample container comprises nanowires or carbon nanotubes (CNT) in a liquid suspension.

16. The system of claim 15, wherein at least one of the following applies:
(a) the CNT or nanowire is about 0.1 to about 15 μm in length;
(b) the CNT or nanowire has a width dimension that is about 20 to about 10,000 times shorter than the length dimension of the CNT or nanowire;
(c) the plurality of nanowires comprises at least one of a silver nanowire, a gold nanowire, a copper nanowire, a mixed metal nanowire, a nanowire comprising metal oxides, or a biological nanowire; and
(d) the nanowire is conductive.

17-19. (canceled)

20. The system of claim 13, wherein the plurality of electrodes comprises two parallel-plate electrodes.

21. The system of claim 15, wherein the sample container is positioned between the two parallel-plate electrodes.

22. The system of claim 13, further comprising a second polarizer.

23. The system of claim 13, wherein the detector comprises a photodiode.
